(19) United States
(12) Patent Application Publication
(10) Pub. No.: US 2007/0219913 A1
(43) Pub. Date: Sep. 20, 2007

(54) Subscription-based catastrophe-triggered rescue services facilitation method and apparatus

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/381,277

(22) Filed: May 2, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.

(51) Int. Cl. H04L 9/00

(52) U.S. Cl. 705/52

(57) ABSTRACT

One or more non-human-powered vehicles (301, 302) are pre-positioned (102) and maintained (103) at a predetermined location (201) as are corresponding full-time rescue service personnel (104). Consideration-based private civil security subscriptions (307) are then accepted (106) from subscribers with respect to these resources. In particular, such a subscription can provide civilly-catastrophic event-based rescue services for authorized beneficiaries of the subscription using the non-human-powered vehicle and the rescue service personnel to come to the authorized beneficiaries and move the authorized beneficiaries away from a location of substantially sudden civil upheaval. By one approach these assets are reserved, committed, maintained, and used substantially solely as a rescue response to a civilly-catastrophic event.

### RELATED APPLICATIONS

This comprises a continuation-in-part of three earlier filed patent applications entitled:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350; and

PERSONAL PROFILE-BASED PRIVATE CIVIL SECURITY SUBSCRIPTION METHOD as filed on Apr. 11, 2006 and having application Ser. No. 11/279,333; the contents of which are fully incorporated herein by this reference.

This application relates to the following patent applications as were filed on even date herewith (wherein the contents of such patent applications are incorporated herein by this reference):

SUBSCRIPTION-BASED CATASTROPHE-TRIGGERED TRANSPORT SERVICES FACILITATION METHOD AND APPARATUS (8379/87821);

FRACTIONALLY-POSSESSED UNDERGROUND SHELTER METHOD AND APPARATUS (attorney's docket number 8379/87822); and

SUBSCRIPTION-BASED MULTI-PERSON EMERGENCY SHELTER METHOD (8379/87823).

### TECHNICAL FIELD

This invention relates generally to facilitating rescue services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or human-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

When a civilly-catastrophic event occurs, substantially sudden civil upheaval will often follow. Such upheaval, which can occur even without the advent of an uncooperative and/or panicked populace, can in turn lead to considerable survival-related problems for persons within the affected location. In many cases it may be useful or even critical to at least temporarily evacuate the troubled location. Therein, however, lies something of a conundrum. On the one hand, modern governments typically do little to proactively ensure the ability to quickly and safely effect transport of their citizens in the face of most civilly-catastrophic events. On the other hand, attempting to take responsible actions to reasonably ensure one's own abilities in this regard can become, in and of itself, a seemingly insurmountable challenge. For example, even when survival facilities (such as, for example, an emergency shelter) are available, a given individual may lack the means, expertise, skills, or ability to safely reach that facility during a time of need.

### BRIEF DESCRIPTION OF THE DRAWINGS

The above needs are at least partially met through provision of the subscription-based catastrophe-triggered rescue services facilitation method and apparatus described in the following detailed description, particularly when studied in conjunction with the drawings, wherein:

FIG. 1 comprises a flow diagram as configured in accordance with various embodiments of the invention;

FIG. 2 comprises a top plan schematic block diagram view as configured in accordance with various embodiments of the invention; and

FIG. 3 comprises a top plan schematic block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one or more non-human-powered vehicles are pre-positioned and maintained at a predetermined location as are corresponding full-time rescue service personnel. Consideration-based private civil security subscriptions are then accepted from subscribers with respect to these resources. In particular, such a subscription can provide civilly-catastrophic event-based rescue services for authorized beneficiaries of the subscription using the non-human-powered vehicle and the rescue service personnel to come to the authorized beneficiaries and move the authorized beneficiaries away from a location of substantially sudden civil upheaval. By one approach these assets are reserved, committed, maintained, and used substantially solely as a rescue response to a civilly-catastrophic event.

The nature of the non-human-powered vehicle can vary with the needs and/or opportunities as characterize a given application setting. Various kinds of transport modality, for example, can be accommodated in this manner. This can include air-borne vehicles, terrestrial vehicles, water-borne vehicles, and so forth. The number of non-human-powered vehicles provided at the predetermined location can vary as well. For example, by one approach, a sufficient number of vehicles can be provided to ensure a fully redundant back-up capability to facilitate the rescue of the full number of authorized beneficiaries as correspond to the transport subscriptions for the predetermined location.

Rescued authorized beneficiaries can be moved to whatever destination(s) may be applicable in a given application setting. By one approach all of the authorized beneficiaries can be transported to a rally point where they (and possibly other authorized beneficiaries) are then transported in a more usual fashion to an emergency shelter. By another approach such authorized beneficiaries can be transported to a destination of their own choosing (such as privately owned shelter or other available refuge).

These steps are facilitated without dependency upon governmental oversight, participation, or control. The particular rescue services provided can vary with the needs and requirements of the authorized beneficiaries. Importantly, via these teachings an individual can take important steps to bring a considerably improved measure of security into their lives, knowing that, should a civilly-catastrophic event indeed be visited upon them, they will be rescued and moved, safely and effectively, from a location of (and possibly through) civil upheaval.

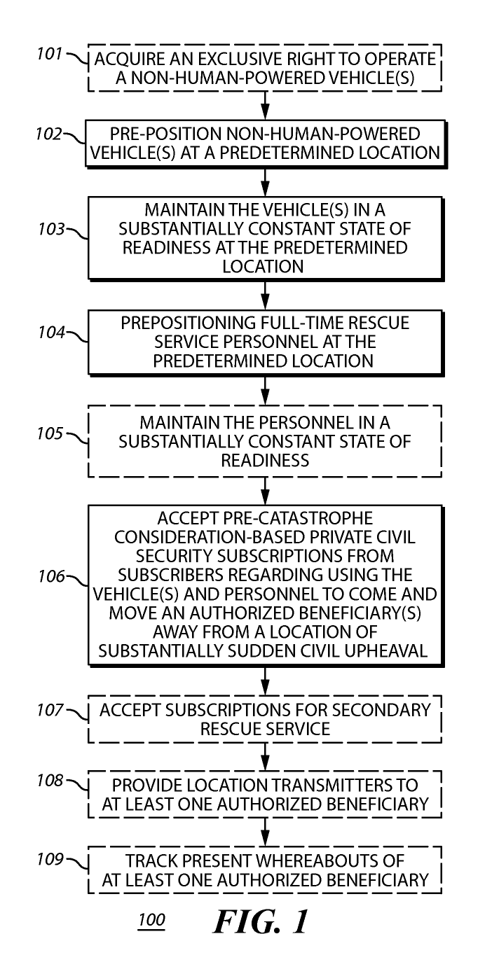

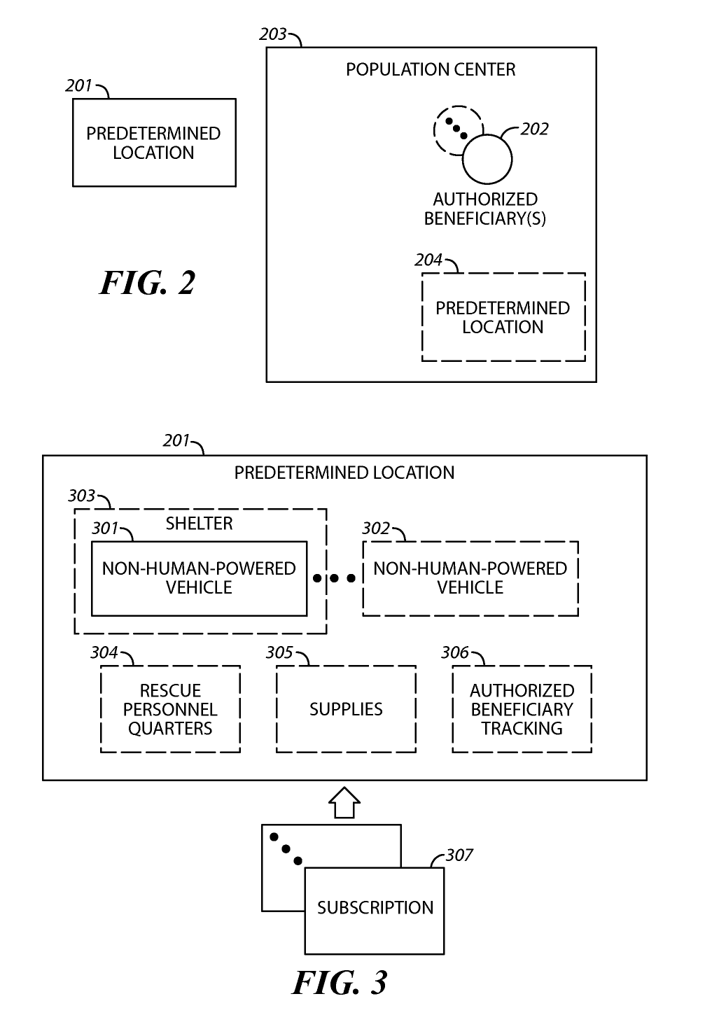

These and other benefits may become clearer upon making a thorough review and study of the following detailed description. Referring now to both FIG. 1 and FIG. 2, an illustrative process 100 provides for pre-positioning 102 at least one non-human powered vehicle at a predetermined location 201. By one approach this may comprise, or be preceded by, optionally acquiring 101 an exclusive right to operate the non-human powered vehicle. There are many ways by which such an exclusive right can be so acquired. A non-exhaustive listing might include, but is not limited to, acquiring the exclusive right via ownership, leasing, rental, or even a barter arrangement. If desired, of course, one might design and build the non-human-powered vehicle themselves.

In many cases it may be helpful to dispose such a predetermined location 201 relatively proximal to one or more authorized beneficiaries 202. Such a position may aid with facilitating the timely rescue of such authorized beneficiaries 202 during a time of need. Such proximity may be measured, for example, by distance and/or by a period of time as may reasonably be required to traverse the distance between the predetermined location 201 and at least some of the authorized beneficiaries 202. Sensitivities in this regard may vary in response to various influences including but not limited to subscriber wishes, applicable relevant threat scenarios, and the like. In some cases, as when the authorized beneficiaries 202 reside or are otherwise often located within a significant population center 203 (such as a city or large town) it may be useful to dispose a (or an additional) predetermined location 204 within the population center 203 itself.

Referring now to FIG. 1 and FIG. 3, the non-human powered vehicle 301 itself can vary greatly with respect to the actual and/or anticipated circumstances as may concern its eventual use as a means of rescuing others and transporting them away from a location of substantially sudden civil upheaval as has been occasioned by a civilly-catastrophic event. This can include differences with respect to the transport modality (or modalities) that characterizes the non-human powered vehicle 301. Examples include, but are not limited to, air-borne vehicles (including fixed wing aircraft, helicopters, and hovercraft, to note but a few), terrestrial vehicles (including cars, buses, trucks, motorcycles, and trains, to note but a few), and water-borne vehicles (including boats and ships, submarines, and amphibious craft, again to note but a few relevant examples).

In many cases the non-human powered vehicle 301 will comprise a terrestrial vehicle. In such a case it may be useful to configure and arrange the non-human powered vehicle 301 to be able to traverse off-road conditions. Such a capability may be useful, for example, to successfully move past debris, stalled, blocked, or abandoned vehicles, impassable roadways, and so forth. This can comprise configuring the vehicle with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

In many cases the non-human powered vehicle 301 will comprise a terrestrial vehicle that has a free-ranging capability to thereby freely navigate paved and unpaved surfaces of various kinds. In some cases, however, it may be useful to further configure and arrange the vehicle to also selectively travel compatibly on railroad tracks. This may comprise, for example, outfitting the vehicle with flanged wheels that can be selectively lowered to interact compatibly with a set of railroad tracks. Such apparatus is known in the art. So configured, the non-human powered vehicle 301 can selectively readily travel on railroad tracks which may, in a given time of need, comprise a relatively unblocked means of entering, moving within, and/or departing from a location of civil upheaval.

In many cases the non-human powered vehicle 301 will be configured and arranged to transport human passengers. This may of course include rescue service personnel. As will be explained below in more detail, these human passengers may also likely comprise, for example, the authorized beneficiaries of certain subscriptions 307 as pertain to using the non-human powered vehicle for purposes of rescue. If desired, however, the non-human powered vehicle 301 may further be configured to additionally transport non-human cargo. This cargo may comprise consumables to support the passengers subsequent to their rescue, personal items that belong to the passengers, and so forth.

Such cargo may also comprise, at least in part, pre-supplied rescue supplies. (Such supplies may be pre-positioned within the vehicle(s) or may, at least in part, be stored separately in appropriate storage facilities 305 at the predetermined location or otherwise.) The precise nature of the rescue supplies will of course vary with the application setting. An illustrative non-exhaustive listing in this regard could include:
authorized beneficiary locator apparatus (such as, but not limited to, navigational devices that receive wireless updates regarding a present (or near term, such as within the past 15 minutes or so) location of a given authorized beneficiary, homing device tracking equipment, and so forth);
low-light (including no-light) vision equipment (to facilitate rescue operations in vision-impaired settings);
non-lethal weapons and corresponding ammunition (such as, but not limited to, rubber bullet-firing weapons, electrical charge-conveying weapons, nets, concussive incapacitation devices, drug-imparting darts, tear gas, and so forth);
lethal weapons and corresponding ammunition (such as, but not limited to, standard handheld and/or mounted firearms, knives, bows and arrows, crossbows and bolts, and so forth);
fire-fighting equipment (such as, but not limited to, fire extinguishing supplies and tools, barrier breaching equipment and tools, flame retardant garments, auxiliary breathing equipment, and so forth);
climbing equipment (such as, but not limited to, rope, pitons, rappelling gear, gripping handwear and footwear and related powders and substances, pulleys, and so forth);
first aid equipment (such as, but not limited to, first responder medical equipment and supplies, automatic external defibrillators, oxygen, lost blood replacements (such as blood, plasma, artificial blood, and so forth), wound dressings, stretchers and body boards, and so forth);
human restraining equipment (such as, but not limited to, personal restraint devices, handcuffs, ties, and so forth) to restrain, when necessary, persons interfering with a rescue, an unduly uncooperative authorized beneficiary, and so forth;
electronic navigation equipment (such as, but not limited to, global positioning system-based equipment and aids, maps (in hardcopy and or virtual form), a compass, and so forth);
flotation equipment (such as, but not limited to, personal floatation equipment for rescue service personnel, authorized beneficiaries, and so forth); at least one parachute (to permit, for example, delivery of rescue service personnel, their equipment, and/or other rescue-related material);
a deployable barrier (such as, but not limited to, personnel barriers (for example, barbed wire, razor wire, and so forth), vehicular barriers, and so forth);
free-standing deployable emergency lights (such as, but not limited to, electrically powered lights, constantly illuminated lights, flashing lights, chemically active lights (such as flares), and so forth);
whistles (such as noise makers of various kinds to aid, for example, with signaling, warning, and the like);
lock-picking equipment (such as, but not limited to, tumbler pin and wafer picks, rakes and raking devices, and other lock mechanism engagement and manipulation members);
two-way wireless communications equipment (such as, but not limited to, equipment using carriers of essentially any useful frequency, terrestrial and/or satellite-based infrastructure, infrastructureless platforms, and so forth);
ground penetrating radar;
personal armor (such as, but not limited to, helmets, vests, gloves, boots, and so forth and containing projectile resistant or projectile proof materials such as Kevlar, metal, and so forth);
deployable lighter-than-air vehicles configured and arranged to lift at least one authorized beneficiary (such as, but not limited to, hot air or helium balloons); extraction equipment;
digging equipment;
cutting equipment;
vapor analyzers and related evaluation equipment; and
explosives;
   to note but a few.

In at least some cases it may be anticipated that the civilly-catastrophic event of concern and/or the corresponding civil upheaval may involve, at least in part, unhealthy and/or dangerous ambient airborne contaminants. Examples include, but are not limited to, dangerous biological elements, dangerous chemical elements (including acidic gases), dangerous radioactive elements, and so forth. These examples include both man-made and natural contaminants; for example, “chemical elements” can include both a man-made nerve gas and volcanic ash. By one approach, then, the non-human powered vehicle 301 can comprise one or more passenger cabins that are substantially airtight. If desired, this can comprise configuring and arranging the passenger cabin to selectively have positive air pressure when desired to aid in urging external airborne contaminants from entering the passenger cabin. Various ways and means are known in the art by which to provide positive air pressure in a contained space and therefore require no further detailed description here. As an alternative (or in combination with the above approaches), the vehicle cabin can be configured to include masks, hoods, or other contrivances to facilitating delivering safe breathing gases to the passengers when the ambient environment may be dangerous to breath.

At least some civilly-catastrophic events may be accompanied by an electromagnetic pulse. Such a pulse can permanently damage many electrical circuits including, for example, the electronic engine controls (including but not limited to a so-called electronic control module (ECM)) for a vehicle. With this in mind, it may be desirable to harden at least the critical vulnerable systems of the non-human powered vehicle 301 to thereby substantially protect those systems against an electromagnetic pulse. Again, various ways and means of achieving such a result are known in the art and may be practiced here as desired.

As already alluded to above, the purpose of pre-positioning the non-human powered vehicle 301 is to ensure its availability during a time of great need. Unfortunately, such a time will, essentially be definition, be characterized by significant temporary or permanent problems with the infrastructure of modern life. As a result, various significant mission-threatening problems can arise when seeking to use the non-human powered vehicle 301 to rescue one or more authorized beneficiaries and move them away from a location of civil upheaval during such a time. As a result, it may be desirable to further outfit the non-human powered vehicle 301 in various other ways to better improve the prospects of the vehicle being able to successfully carry out its rescue mission.

This can comprise pre-supplying the non-human powered vehicle 301 with any of a variety of material that is designed to facilitate at least one of improving survivability of the passengers, improving the likelihood that the vehicle can complete its designated travel, and so forth. Examples in this regard include, but are certainly not limited to:
body armor (designed to stop at least low caliber small arms fire and offering higher ballistic protection if desired, including both bulletproof windows, louvered view ports, and armored passenger compartments and/or vehicle compartments);
radiation shielding;
biological/chemical agent protection (including but not limited to the aforementioned positive air pressure capability, decontamination facilities, sealed compartments, and so forth);
medical supplies (including but not limited to first aid supplies as well as first responder emergency medical services supplies such as blood, plasma, automatic external defibrillators, radiation exposure treatments, chemical exposure treatments, antibiotics (including but not limited to medicines such a Tamiflu and the like), and so forth);
spare vehicle parts (including but not limited to mission critical parts relating to the vehicle's drive train, propulsion system, trajectory controls, important electrical components such as, but not limited to, an electronic control module (ECM), and so forth);
vehicular maintenance tools;
supplemental vehicular fuel supplies (carried in on-board auxiliary fuel tanks and/or non-integral fuel containers of choice).

This step can comprise pre-positioning more than one non-human powered vehicle. In many cases it will be desirable to pre-position at least two such vehicles though many more may be appropriate in some settings. When providing a plurality of non-human powered vehicles, their transport modalities may be the same or may differ as desired. By one approach this additional vehicle 302 (or vehicles) can represent redundant capacity and capability and hence can serve as a backup for the first vehicle 301. By this approach, the second vehicle 302 can comprise, for example, passenger transport capacity that at least doubles the overall available transport capacity as is represented by the aforementioned subscriptions. Such redundancy with respect to capacity can aid with assuring, in turn, that a given rescue effort can be successfully effected notwithstanding the difficult circumstances likely to characterize the effort.

By one approach, if desired, a first non-human powered vehicle 301 can comprise a vehicle that is intended to transport a particular group of rescued authorized beneficiaries while a second (and/or more) non-human powered vehicle 302 comprises a security vehicle that is intended to accompany the first non-human powered vehicle 301 when the first non-human powered vehicle 301 makes its assigned transit. So configured, this security vehicle can be intended to perform such tasks as scouting candidate paths ahead of the first non-human powered vehicle 301, following the first non-human powered vehicle 301, or other security/protection related tasks as may be strategically or tactically advisable or useful in a given application setting.

This process 100 also provides for maintaining 103 the non-human powered vehicle 301 in a substantially constant state of readiness at the predetermined location 201. This can comprise, in part, optionally maintaining and storing the non-human powered vehicle 301 in a substantially shelter area 303 at the predetermined location 201 for at least a substantial period of time pending a civilly-catastrophic event. This substantially sheltered area 303 can be configured to house a plurality of such vehicles if desired. By one approach the substantially sheltered area 303 may comprise a substantially covered area that essentially comprises only a roof. By another approach the substantially sheltered area 303 may also comprise one or more walls as well to further aid in protecting the vehicle(s) from the elements, unauthorized access, prying eyes, and so forth. By yet another approach the substantially sheltered area 303 can comprise one or more walls disposed around the vehicle (for example, earthen and/or concrete works formed in a U shape can be employed in this manner) that lack a roof or other overhead cover. It would also be possible to place such a vehicle shelter partially or wholly underground.

Such maintenance can also optionally comprise making adjustments to pre-positioned supplies, such as those mentioned above, to reflect dynamically changing circumstances as occur during the consideration-based private civil security subscription period. As one illustration, a new item may become available that is particularly useful in dealing with or otherwise surmounting some condition that may likely arise upon the occurrence of a particular kind of civilly-catastrophic event. In such a case, maintaining such supplies can readily accommodate updating the acquired and stored items to include a supply of this new item.

Accordingly, such maintenance can readily comprise one or more of removing a particular one of the stored items (as when a better substitute becomes available, when the item itself is shown to be less effective for its intended purpose than was originally thought, and so forth), adding additional ones of a particular item (as when it becomes subsequently understood that more of a particular item is desirable to achieve a particular goal or purpose), adding at least one new stored item that is not already stored (as illustrated in the example provided above), and so forth.

This step of maintaining 103 the non-human powered vehicle 301 can also comprise one or more maintenance activities. Examples include, but are not limited to:
conducting vehicle maintenance;
providing a supplemental supply of fuel in relatively close proximity to the non-human-powered vehicle, which supplemental supply of fuel is dedicated to use with the non-human powered vehicle(s) at the predetermined location;
providing a store of spare parts for the non-human powered vehicle at the predetermined location;
test-driving the non-human powered vehicle from time to time (for example, on a scheduled basis and/or an un-scheduled basis); and
test-operating the non-human powered vehicle from time to time.

This process 100 also comprises providing 104 at least one full-time rescue service personnel. By one approach this can comprise providing rescue personnel quarters 304 at the predetermined location 201 such that the at least one full-time rescue service personnel is available to facilitate substantially immediate initiation of a rescue effort in response to a civilly-catastrophic event. By one approach, for example, rescue service personnel crews could be rotated on a 24 hour basis. If desired, such personnel can be quartered proximal to the predetermined location 201 rather than at the predetermined location. For example, such quarters could be located within, say, one mile of the predetermined location 201 or such other distance that will not represent an undue obstacle during a time of need.

The duties of such personnel can and will vary with the specific kind of vehicle and also with the anticipated nature of any particular rescue task(s). Exemplary duties comprise, but are not limited to, tracking present (or near-present) locations of one or more authorized beneficiaries, piloting the vehicle, co-piloting the vehicle, navigating the vehicle, conducting two-way wireless communications on behalf of the vehicle during a rescue effort, managing or otherwise overcoming mission obstacles, managing, serving, and otherwise attending to the needs of rescued authorized beneficiaries, providing security, and so forth.

This process 100 can optionally accommodate maintaining 105 the rescue service personnel in a substantially constant state of readiness. This can comprise, for example, conducting test drills with such personnel and/or with the intended passengers (i.e., the authorized beneficiaries of the previously mentioned subscriptions). Such drills can comprise, for examples, drills to practice locating and making contact with authorized beneficiaries, operating the non-human powered vehicle 301, identifying and controlling or overcoming any of a variety of potentially mission-impairing obstacles, and performing and/or experiencing other circumstances or events of possible relevance or interest. Such drills may also entail, if desired, simulated and/or replicated rescue conditions that may pose a particular challenge if encountered during a non-drill rescue mission.

These teachings then provide generally for accepting 106 consideration-based private civil security subscriptions 307 from subscribers with respect to providing civilly-catastrophic event-based rescue services by which the aforementioned vehicle(s) and personnel come to the authorized beneficiaries and move the authorized beneficiaries away from a location of substantially sudden civil upheaval. By one approach, these rescue resources are reserved, committed, maintained, and used substantially solely as a rescue response to a civilly-catastrophic event of significant scale and impact. So configured, an authorized beneficiary would use, for example, standard 911 resources when dealing with everyday problems involving safety, health, fire, crime, and so forth that present a challenge on a scale that local government and/or resources can be expected to readily handle.

This right of rescue can pertain, if desired, to a predetermined timeframe. For example, a given subscription 307 can relate to providing rescue as may be required during a given one year period for one or more authorized beneficiaries as are covered by a given subscription. If desired, a given subscription can further provide for transportation back to the original location of civic upheaval following substantial quelling of that civil upheaval. This transportation may be by the non-human powered vehicle as was used to originally convey the authorized beneficiaries away from that location or may comprise other more customary civilian-styled transport (presuming, for example, that obstacles and inhibitions with respect to transport are no longer as extreme as when the original transport was provided).

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of rescue (as where a subscription provides rescue rights for a specific period of time, such as one year, in exchange for a corresponding series of payments);

event-limited rights of rescue (as where a subscription provides rescue rights during the life of a given subscriber based upon an up-front payment in full and where those rescue rights terminate upon the death of the subscriber or where, for example, a company purchases a subscription for a key employee and those corresponding rights of rescue terminate when and if that key employee leaves the employment of that company);

inheritable rights of rescue (as may occur when the subscription, by its own terms and conditions, provides a right of rescue that extends past the death of a named subscription beneficiary and further allows for testate and/or intestate transfer to an heir);

rights of rescue predicated upon a series of periodic payments (as where a subscription provides rescue rights during, for example, predetermined periods of time on a periodic basis as where a subscriber offers month-by-month payments to gain corresponding month-by-month rescue rights);

rights of rescue predicated upon a one-time payment (as may occur when a subscriber makes a single payment to obtain a time-based or event-based duration of rescue rights or, if desired, when a single payment serves to acquire a perpetual right of rescue that may be retained, transferred, inherited, or the like);

ownership-based rights of rescue (as may occur when the subscription provides for ownership rights regarding rescue);

non-transferable rights of rescue (as may occur when the subscription, by its terms and conditions, prohibits transfer of the right of rescue from a first named beneficiary to another);

transferable rights of rescue (as may occur when the subscription, by its terms and conditions, permits conditional or unconditional transfer of the right of rescue from a first named beneficiary to another);

membership-based rights of rescue (as may occur when the subscription, by its terms and conditions, establishes a membership interest with respect to the accorded right of rescue such as, for example, a club-based membership);

fractionally-based rights of rescue (as may occur when the subscription, by its terms and conditions, establishes a divided or undivided co-ownership interest by and between multiple subscription beneficiaries with respect to a right of rescue);

rights of rescue predicated upon an obligation to make a future payment (as may occur when a subscriber obligates him or herself to pay a particular sum at such future time as they may, in fact, be so rescued); and/or

non-ownership-based rights of rescue (as may occur when the subscription, by its terms and conditions, establishes the aforementioned right of rescue via, for example, a lease, rental, or borrowing construct).

If desired, a plurality of differentiated subscription opportunities can be offered in this regard. This plurality of differentiated subscription opportunities can correspond, for example, to providing access to differing transport modalities, transport accommodations, predetermined locations, and so forth. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing rescue services that are economically selected (by excluding, for example, certain options such as medical services or the like) while another subscription might provide for rescue services that are more costly and in turn reflect, for example, a wider variety of choices with respect to rescue modality, accommodations, service options, creature comforts, and so forth.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist. It is also possible that a given subscription could pertain to a non-human authorized beneficiary such as a pet, work of art, or other object of objective or subjective great value.

As noted, these subscriptions relate to providing rescue in the event of a civilly-catastrophic event. Such transport may be predicated, if desired, upon a requirement that the civilly-catastrophic event be one that persists in substantial form for more than a predetermined period of time (such as one hour, one day, one week, and so forth) or that causes at least a predetermined amount or degree of civil infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one medical service that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

As one option, if desired, this process 100 can further accommodate accepting 107 what amounts to a secondary subscription for secondary rescue rights. By this approach, less expensive subscriptions can be provided for rescue if and when a first tier of primary authorized beneficiaries are successfully rescued. By one approach, if desired, the primary subscribers could share, at last partially, in the consideration offered by such secondary subscribers.

These teachings can then of course provide for confirming the occurrence of a triggering civilly-catastrophic event and responsively then permitting subscription-based transport using the aforementioned resources. This may comprise, if desired, use of a mechanism that the authorized beneficiary carries with them to confirm their authorized status in this regard. This mechanism can comprise personal property (such as an identification card) or can comprise, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of receiving necessary or helpful transport following a civilly-catastrophic event. These teachings are sufficiently flexible so as to accommodate the needs and desires of a wide-ranging set of potential beneficiaries.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

For example, by one optional approach, these teachings can further provide for providing 108 location transmitters to at least some of the authorized beneficiaries to facilitate locating and rescuing these authorized beneficiaries in the event of a civilly-catastrophic event. Such a transmitter may comprise a device that automatically and autonomously transmits such information from time to time (such as every second, every minute, every 10 minutes, or the like) and/or can comprise a device that transmits such information in response to a wireless remote control signal as sourced, for example, by the aforementioned rescue personnel. Regardless of whether such a transmitter-based location tracking approach is employed, these described processes 100 could be configured and arranged to provide for tracking 109 the present (or at least substantially present) whereabouts of at least some of the authorized beneficiaries to facilitate their rescue in a time of need via, for example, corresponding authorized beneficiary tracking facilities 306 as may be provided at the predetermined location 201.

By another approach, if desired, a beacon or other transmission may be sourced from, or near, a location to which the authorized beneficiaries are to move themselves in order to aid with facilitating their own rescue. In such a case the corresponding authorized beneficiaries could be supplied with a device that is configured and arranged to locate the homing signal or information and aid the authorized beneficiary with navigating to that location.

As another example, these teachings could accommodate the pre-positioning of movable containers at specific locations. For example, such a container could be placed atop a tall building in a dense urban setting such as a large city. Authorized beneficiaries could be provided with information regarding the location of such containers as well as the means to open such a container in a time of need. During a time of need, such an authorized beneficiary could proceed to the container and place themselves within it. The rescue services provided by these teachings could then provide for attaching a cable to the container and moving the container and the authorized beneficiary(s) within it to a safe location via, for example, a helicopter. Such a container could be provided with a location beacon that can serve to aid the authorized beneficiaries with respect to locating the container. If desired, the container could contain communications equipment and/or sensors of various types by which rescue service personnel can learn that one or more authorized beneficiaries are in the container awaiting pick up.

I claim:

1. A method comprising:
pre-positioning a non-human-powered vehicle at a predetermined location;
maintaining the non-human-powered vehicle in a substantially constant state of readiness at the predetermined location;
pre-positioning full-time rescue service personnel at least proximal to the predetermined location;
accepting pre-catastrophe consideration-based private civil security subscriptions from subscribers with respect to providing civilly-catastrophic event-based rescue services for authorized beneficiaries using the non-human-powered vehicle and the rescue service personnel to come to the authorized beneficiary and move the authorized beneficiary away from a location of substantially sudden civil upheaval;
such that the non-human-powered vehicle and the rescue service personnel are reserved, committed, maintained, and used substantially solely as a rescue response to a civilly-catastrophic event.

2. The method of claim 1 wherein pre-positioning a non-human-powered vehicle at a predetermined location comprises pre-positioning at least one of:
an aircraft;
a terrestrial vehicle;
a water-borne vehicle;
a hovercraft;
an amphibious vehicle.

3. The method of claim 1 wherein pre-positioning a non-human-powered vehicle at a predetermined location comprises pre-positioning a terrestrial vehicle that is configured and arranged to traverse off-road conditions.

4. The method of claim 1 wherein pre-positioning a non-human-powered vehicle at a predetermined location comprises pre-positioning a terrestrial vehicle that is configured and arranged to travel compatibly on both paved surfaces and railroad tracks.

5. The method of claim 1 wherein pre-positioning a non-human-powered vehicle at a predetermined location comprises pre-positioning a terrestrial vehicle that is configured and arranged to transport human passengers comprising authorized beneficiaries of the subscriptions.

6. The method of claim 5 wherein pre-positioning a non-human-powered vehicle at a predetermined location comprises pre-positioning a terrestrial vehicle that is further configured and arranged to additionally transport non-human cargo.

7. The method of claim 1 wherein maintaining the non-human-powered vehicle comprises maintaining the non-human-powered vehicle in a substantially sheltered area for at least a substantial period of time pending a civilly-catastrophic event.

8. The method of claim 7 wherein the substantially sheltered area comprises, at least in part, a substantially covered area.

9. The method of claim 1 wherein maintaining the non-human-powered vehicle comprises at least one of:
conducting vehicle maintenance;
providing a supplemental supply of fuel in relatively close proximity to the non-human powered vehicle, which supplemental supply of fuel is dedicated to use with the non-human powered vehicle;
providing a store of spare parts for the non-human-powered vehicle at the predetermined location;
test-driving the non-human-powered vehicle from time to time;
test-operating the non-human-powered vehicle from time to time.

10. The method of claim 1 wherein pre-positioning a non-human-powered vehicle comprises pre-positioning a non-human-powered vehicle having a passenger cabin that is substantially airtight.

11. The method of claim 10 wherein pre-positioning a non-human-powered vehicle further comprises pre-positioning a non-human-powered vehicle that is configured and arranged to at least selectively have positive air pressure within a passenger cabin thereof

12. The method of claim 1 further comprising maintaining the rescue service personnel in a substantially constant state of readiness.

13. The method of claim 12 wherein maintaining the rescue service personnel in a substantially constant state of readiness comprises conducting test drills with the rescue service personnel using the non-human-powered vehicle.

14. The method of claim 13 wherein maintaining the rescue service personnel in a substantially constant state of readiness comprises conducting test drills with the authorized beneficiaries.

15. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

16. The method of claim 1 further comprising:
accepting pre-catastrophe consideration-based private civil security secondary subscriptions from subscribers with respect to providing civilly-catastrophic event-based secondary rescue service away from a location of substantially sudden civil upheaval, which secondary rescue service is provided following completion of rescuing a primary class of authorized beneficiaries away from the location of substantially sudden civil upheaval.

17. The method of claim 1 further comprising:
acquiring an exclusive right to operate the non-human-powered vehicle.

18. The method of claim 17 wherein acquiring an exclusive right to operate the non-human-powered vehicle comprises acquiring the exclusive right via:
ownership;
leasing;
rental;
a barter arrangement.

19. The method of claim 1 wherein pre-positioning a non-human-powered vehicle at a predetermined location comprises pre-positioning a non-human-powered vehicle that is pre-supplied with rescue supplies.

20. The method of claim 19 wherein the rescue supplies comprise at least one of:
authorized beneficiary locator apparatus;
low-light vision equipment;
non-lethal weapons and corresponding ammunition;
lethal weapons and corresponding ammunition;
fire-fighting equipment;
climbing equipment;
first aid equipment;
first responders medical equipment;
human restraining equipment;
electronic navigation equipment;
flotation equipment;
at least one parachute;
a human barrier;
free-standing deployable emergency lights;
whistles;
lock-picking equipment;
two-way wireless communications equipment;
ground penetrating radar;
personal armor;
deployable lighter-than-air vehicle configured and arranged to lift at least one authorized beneficiary;
extraction equipment;
digging equipment;
cutting equipment;
explosives.

21. The method of claim 1 further comprising:
providing location transmitters to at least some of the authorized beneficiaries to facilitate locating and rescuing the authorized beneficiaries in the event of a civilly-catastrophic event.

22. The method of claim 21 wherein the location transmitters automatically transmit location information.

23. The method of claim 21 wherein the location transmitters transmit location information in response to receiving a wireless remote control signal.

24. The method of claim 1 further comprising:
tracking present whereabouts of at least some of the authorized beneficiaries on a substantially continual basis to facilitate locating and rescuing the authorized beneficiaries in the event of a civilly-catastrophic event.

25. The method of claim 1 wherein the authorized beneficiary comprises at least one of:
a human;
a non-human animal;
a non-living item.

26. The method of claim 1 further comprising:
pre-positioning an enclosure;
instructing at least one authorized beneficiary to enter the enclosure in response to a last a likely occurrence of the substantially sudden civil upheaval; and wherein moving the authorized beneficiary comprises moving the enclosure with the at least one authorized beneficiary disposed therein.

27. An apparatus comprising:
a predetermined location;
at least one non-human-powered vehicle disposed at the predetermined location, wherein the non-human-powered vehicle is maintained in a substantially constant state of readiness;
quarters for full-time rescue service personnel;
a plurality of pre-catastrophe consideration-based private civil security subscriptions from subscribers with respect to providing rescue services for authorized beneficiaries using the non-human-powered vehicle and the rescue service personnel to come to the authorized beneficiary and move the authorized beneficiary away from a location of substantially sudden civil upheaval;
wherein the non-human-powered vehicle and the rescue service personnel are reserved, committed, maintained, and used substantially solely as a rescue response to a civilly-catastrophic event.

28. The apparatus of claim 27 wherein the non-human-powered vehicle comprises at least one of:
an aircraft;
a terrestrial vehicle;
a water-borne vehicle;
a hovercraft;
an amphibious vehicle.

29. The apparatus of claim 28 wherein the non-human-powered vehicle comprises a terrestrial vehicle that is configured and arranged to traverse off-road conditions.

30. The apparatus of claim 28 wherein the non-human-powered vehicle is configured and arranged to travel compatibly on both paved surfaces and railroad tracks.

31. The apparatus of claim 27 wherein the non-human-powered vehicle is configured and arranged to transport human passengers comprising authorized beneficiaries of the subscriptions.

32. The apparatus of claim 27 wherein the predetermined location comprises, at least in part, a covered shelter for the non-human-powered vehicle.

33. The apparatus of claim 27 wherein the non-human-powered vehicle comprises a passenger cabin that is substantially airtight.

34. The apparatus of claim 33 wherein the non-human-powered vehicle is configured and arranged to at least selectively have positive air pressure within a passenger cabin thereof.

35. The apparatus of claim 27 further comprising:
authorized beneficiary tracking means for facilitating locating and rescuing the authorized beneficiaries in the event of a civilly-catastrophic event.
